(19) United States
(12) Patent Application Publication
(10) Pub. No.: US 2015/0295726 A1
(43) Pub. Date: Oct. 15, 2015

(54) Communications platform

(71) Applicant: Kenneth Bland, Edison, NJ (US)

(72) Inventor: Kenneth Bland, Edison, NJ (US)

(21) Appl. No.: 14/120,015

(22) Filed: Apr. 15, 2014

(51) Int. Cl. H04L 12/18; H04L 29/08; H04L 29/06

(52) U.S. Cl. CPC H04L 12/189; H04L 67/42; H04L 67/2823; H04L 65/601

(57) ABSTRACT

A communications platform for mobile devices transmits data (such as alert messages) to at least one mobile device user. The platform comprises a server and an alert client responsible for receiving alert messages sent by the server. The alert client may also perform specific functions on a mobile communications device to insure that the alert message does not remain unnoticed or ignored. The platform may further comprise a cell broadcast service server to limit transmission of an alert message to mobile device users in a particular locality or localities.

### CROSS-REFERENCE TO RELATED APPLICATIONS

The present application is a continuation-in-part of and claims priority under 35 U.S.C. §119 to U.S. Utility patent application Ser. No. 12/919,231, filed on Aug. 25, 2010 which, in turn, is a continuation of and claims priority to U.S. Utility patent application Ser. No. 13/190,606, filed on Jul. 26, 2011 which, in turn, is a continuation of and claims priority to U.S. Utility patent application Ser. No. 12/919,231, filed on Aug. 25, 2010, the disclosures of which are incorporated herein specifically by reference thereto.

### 1. FIELD OF THE INVENTION

The present disclosure generally relates to distribution and transmission of data to users and clients; and, more particularly, to distribution and transmission of data by way of a communications platform that is not dependent upon a data carrier's network or transmission facilities.

### 2. DESCRIPTION OF RELATED ART

Information moves at the speed of lighting. What happens globally is available on the Internet within seconds. Good news, bad news, and life experiences are all caught on camera or video, uploaded and shared. Most people capture events on their smart phone, tablet, or laptop.

Mobile devices have become a mainstay in almost every market and demographic sector worldwide. The demand for smart phones, tablets and laptops continues to grow exponentially. People use these devices for work and recreation. Television and radio programs, movies, sporting events, and the like are all available online. Independent apps are available with most network programs for use on smart devices. A growing trend involves the use of smart devices as entertainment centers, accessing a number of apps throughout the day to fulfill user needs.

Social media channels, such as those associated with the trade names Facebook, You Tube and Instagram for example, are continuing to expand. More than a billion people worldwide are active social media users. Americans alone stream 15 billion videos per month on You Tube with 35 hours of video being uploaded every minute. Users have to invest the time to take the video, create a channel, upload the video and announce its availability to their intended audience.

There are limited sources for instantaneous mobile broadcasting on the market today. Users need to go to a variety of sources to upload and stream personal videos, connect with their contacts to let them know the video is available, and post links to the video on a number of social media channels. Furthermore, most people access apps and streaming sites on Wi-Fi or cable—keeping them tied to a “hot spot” or 3G network using old technology.

Mobile communication devices and networks facilitate transmitting and receiving data among fellow users of such devices. However, limitations inherent with such devices and networks preclude efficient and widespread distribution of data. Thus, a user may not be able to send a message to a friend or colleague due to the inability of the friend or colleague's device to receive a certain message form, or due to a network's restriction on data transmission.

Further, due to network traffic limitations as well as certain device limitations that restrict the types or forms of messages received, urgent communications may be delayed in transmission or otherwise may not reach a user.

Similarly, data access for mobile devices may be constrained by a mobile device's service carrier such that access is dependent on a carrier's geographical service coverage and particular data plan service and pricing. Also, data access is limited to mobile devices that subscribe to data plans or feature Wireless Application Protocol (“WAP”) browsers. Such data plan and WAP browser configurations exclude mobile devices that are only capable of sending and receiving text messages (i.e., have SMS browsers) and otherwise do not support transfer of multimedia data by accessing the Internet and receiving data thereon.

Short Messaging Service (SMS) and Multimedia Message Service (MMS) technologies are examples of widely-used communication methods for mobile telephone users. These services are inexpensive, reliable, and are compatible with virtually all carrier networks and mobile handsets. The versatile nature of the technologies not only makes them useful for conventional communication usage, but can also serve other vital purposes; including the mass transmission of messages (i.e., to a plurality of mobile handset users).

SMS and MMS have certain drawbacks, however. For example, transmission and receipt of an SMS or MMS message is dependent on a mobile carrier's network capacity. That is, in times of heavy network usage, a message may not be delivered in a timely fashion. Furthermore, delivery of an SMS or MMS message to a handset is usually directed to a particular folder in the handset's file storage system; this, in turn, requires a message recipient user to navigate through a plurality of steps and screens to view the contents of the message. Due to such a cumbersome retrieval scheme, a recipient's viewing of an important message is frequently delayed.

Also, in the event that a user's carrier service subscription does not include a messaging plan, receipt of such messages for such a user may invoke additional costs to the user's service invoice. In such a case, a user may be reluctant to retrieve or view such messages due to the additional associated costs.

Accordingly, there exists a need in the art for communicating data to the multitude of mobile device users, regardless of the users' devices or network subscriptions. Further, there exists a need in the art for a technical solution that enables every day end users of mobile phones, Tablets or IP TVs to stream live events to others in an efficient manner.

### SUMMARY OF THE INVENTION

The present invention obviates disadvantages troubling existing systems while providing for distribution and transmission of data by an independent communications platform that is not dependent upon a data carrier's network or transmission facilities, and is not dependent upon a mobile device user's data plan or subscription.

Transmission of particular data to users, such as data events involving weather and other emergencies is prioritized and directed on the basis of the user's specific location. Data transmission is facilitated by prioritization of various data packets based on preselected criteria, the receipt of which is verified by an automated message receipt confirmation. Advantageously, the communications platform enables every day end users of mobile phones, Tablets or IP TVs to stream live events to others in a highly efficient manner.

More specifically, the present invention provides a method, system and apparatus for social networking of live broadcast events. In one aspect, a mobile broadcasting communication technology platform (MBC) provides a video platform that allows users to view and broadcast video content using a camera and/or a computer through the interne. MBC includes an MBC App for a digital device, such as mobile digital devices including Smartphone, Tablets, computers, as well as non-mobile digital devices, such as Smart TVs, TV, and the like. MBC's App allows a user member originator to broadcast live video from anywhere. Members of the MBC network can broadcast directly from their mobile device using MBC's mobile broadcasting application (available for Smartphone, including those sold under the trade names Android and iPhone). Client application resides as an app in the client side devices. Users can broadcast their video in their channels, utilizing multiple cameras and on-screen graphics. Users may also collaborate with other producers anywhere in the world.

The purpose of the client application is to recognize broadcasts sent from the MBC Server. Client application will reside as an app in the client side devices. Devices currently contemplated include Smart Phone (iPhone, Android Phones, Windows Phone), Tablets on Wi-Fi or 3G or 4G (iPad, Android Tablets, Windows 8 PCs and Windows Surface Or Windows Tablets), Smart TVs (Apple TV, Google TV, Android powered smart TVs and Microsoft IP TVs). The operating systems at the client side can be iOS, Android (all flavors) and Microsoft Windows 7.x and 8.x.

In a first embodiment, a communications platform is provided. The communications platform comprises at least one server, a transport layer, a client, and at least one mobile communications device, wherein the client comprises at least one application operatively coupled to the at least one mobile communications device, the client being capable of communicating with the at least one server of the platform over the transport layer, the client also being capable of receiving a transmission from the at least one server over the transport layer, the client further being capable of displaying said transmission on the at least one mobile communications device upon direction from the at least one server, and the client being further capable of transmitting a return message communicating with the at least one server that a transmission has been displayed on the at least one mobile device, wherein the communications platform is not dependent upon a data carrier's network or carrier's transmission facility and thereby provides an independent communication platform for distribution and transmission of data.

In another embodiment, a communications platform is provided, comprising: at least one server, at least on transport layer, and at least one client comprising at least one application operatively coupled to the at least one transport layer and operatively coupled to at least one mobile communications device, the client being capable of communicating with the at least one server of the platform over the transport layer, and the client being capable of receiving a transmission from the at least one server over the transport layer, the client being further capable of displaying said transmission on the at least one mobile communications device upon prompting from the at least one server.

In another broad embodiment, a mobile cloud application system for a mobile communications platform is provided. The mobile cloud application system is adapted for use with a wireless interactive device capable of receiving and transmitting messages, accepting user interface input, and displaying messages on an electronic display, the mobile cloud application system comprising: at least one server, an Internet Protocol (IP) backbone transport layer for Wi-Fi connectivity, and at least one client comprising at least one application operatively coupled to the at least one transport layer and operatively coupled to at least one wireless interactive device, the client being capable of communicating with the at least one server over the transport layer, the client also being capable of receiving a transmission from the at least one server over the transport layer, and the client being further capable of displaying said transmission on the at least one mobile communications device upon prompting from the at least one server.

A communications method is further provided comprising the steps of: streaming at least one live broadcast from at least one wireless interactive device to at least one cloud with a server having error correction technology, compression and validation software, over a mobile cloud application system for a mobile communications platform, comprising: at least one server, an Internet Protocol (IP) backbone transport layer for Wi-Fi connectivity, and at least one client comprising at least one application operatively coupled to the at least one transport layer and operatively coupled to the at least one wireless interactive device, the client being capable of communicating with the at least one server over the transport layer, the client also being capable of receiving the live broadcast transmission from the at least one server over the transport layer, and the client being further capable of displaying said transmission on the at least one mobile communications device upon prompting from the at least one server; and at least one other wireless interactive device being capable of streaming and displaying the live broadcast.

### BRIEF DESCRIPTION OF THE DRAWINGS

The advantages and features of the present disclosure will become better understood with reference to the detailed description taken in conjunction with the accompanying drawings, wherein like elements are identified with like symbols, and in which:

FIG. 1 illustrates an environment in which various embodiments of the present disclosure may be practiced;

FIG. 2 illustrates a block diagram of an independent communications platform for providing transmission of data access across an information network, in accordance with an embodiment of the present disclosure;

FIG. 3 illustrates a non-limiting depiction of an alert communications platform, in accordance with an exemplary embodiment of the present disclosure;

FIG. 4 illustrates a non-limiting depiction of an alert communications platform, in accordance with another exemplary embodiment of the present disclosure, wherein like reference numerals refer to like parts throughout the description of several views of the drawings;

FIG. 5 illustrates an exemplary embodiment of an overview of the MBC platform;

FIG. 6 illustrates an exemplary embodiment of an overview of the use of a server 601 with error correction technology, compression and validation software integration;

FIG. 7 illustrates a block diagram of an exemplary embodiment of the MBC platform architecture;

FIG. 8 illustrates a block diagram of another exemplary embodiment of the MBC platform architecture;

FIG. 9 illustrates a schematic view of the MBC platform content;

FIG. 10 illustrates a schematic view of the MBC platform server data flow from a first user/user taking/streaming video or content to other users who are identified to view the video or content;

FIG. 11 is a schematic view of flow of data (content) from different sources through the MBC network;

FIG. 12 is a schematic view of the broadcast multicast service center (BMSC) of the MBC network;

FIG. 13 is a schematic view of the BMSC physical architecture;

FIG. 14 illustrates a flow chart of an exemplary embodiment of the MBC flow of client application;

FIG. 15 shows a representative screen snap-shot of the app download;

FIG. 16 shows a representative screen snap-shot of a sample logo and license;

FIG. 17 shows a representative screen snap-shot of the client application;

FIG. 18 shows a representative screen snap-shot of a channel menu;

FIG. 19 shows a representative screen snap-shot of the channel feed;

FIG. 20 shows a representative screen snap-shot of a live feed on display;

FIG. 21 shows a screen snap shot of a list of contacts.

### DETAILED DESCRIPTION OF THE DISCLOSURE

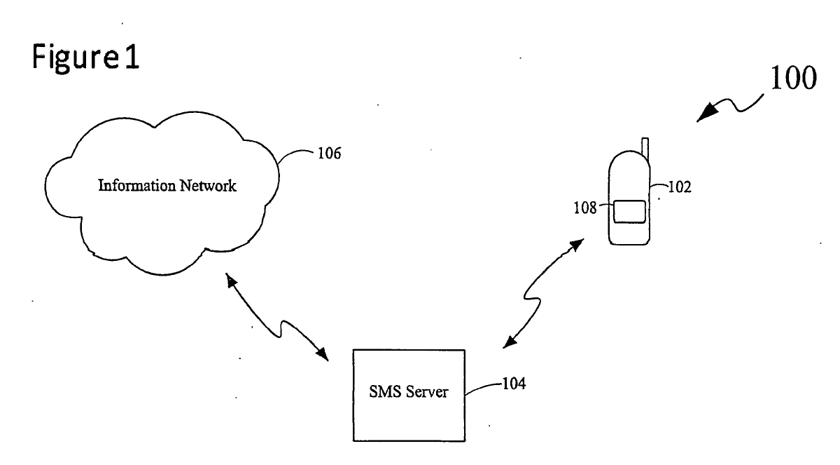

The best mode for carrying out the present disclosure is presented in terms of the embodiment, herein depicted in FIGS. 1 through 21. The embodiments described herein detail for illustrative purposes and are subject to many variations. It is understood that various omissions and substitutions of equivalents are contemplated as circumstances may suggest or render expedient, but are intended to cover the application or implementation without departing from the spirit or scope of the present disclosure. Further, it is to be understood that the phraseology and terminology employed herein are for the purpose of, the description and should not be regarded as limiting. Any headings utilized within description are for convenience only and have no legal or limiting effect.

The terms “a” and “an” herein do not denote a limitation of quantity, but rather denote the presence of at least one of the referenced items.

The subject communications platform provides a live streaming solution backed up by 3G, 4G, LTE networks of mobile operator and Broadcast Multicast Service Centers (BMSC). Error correction technology supported by custom devices and the BMSC are implemented within the subject communications platform to provide powerful broadcasting eliminating or significantly reducing buffering needs. Every day end users of mobile phones, Tablets or IP TVs are capable of broadcasting or live streaming any event of their interest to other BMSC users or non BMSC users with customized devices using error technology, such as that associated under the trade name Kencast. The broadcasting of the events, which are optionally arranged in categories, may also emerge from content providers besides end users. Each category of the live events is preferably broadcasted in a separate channel identified by a unique number.

The subject communications platform utilizes novel mobile streaming technology that uniquely: 1) allows users to stream live video to any of their connections regardless of location in real time, alleviating the need to upload and store content; 2) alerts contacts that the video is streaming live at that moment without having to invest time in going onto various social media channels to announce its availability; 3) may be used with a Wi-Fi or cable connection, or independently with 4G or LTE mobile access; and 4) gives users the opportunity to view many public broadcasts available from television, radio or the mobile broadcast corporation technology platform, making it the central entertainment hub.

Through use of the subject mobile broadcasting communication technology platform (MBC), everyday consumers are capable of utilizing their mobile devices to stream a live video, voice or both to MBC user(s) on a mobile device. Innovative live-streaming technology is supported on 4G and LTE networks, as well as broadcast/multicast service centers. Users can simply point-and-shoot to video and stream an event. When the live streaming is initiated, the MBC user application is initiated which sends a request over the mobile 4G or LTE network to activate the streaming. A separate MBC server will authenticate the live stream and send a notice to all MBC users that agree to receive live streams from the originator (person making and streaming the video).

The MBC solution is an app available to mobile device users through an App Store, the Internet, or on a MBC website. Each user will have a unique MBC channel. MBC User Community Members have the ability to “tag” or identify people in their videos. “Tagged” people that are a member of the MBC User Community will be notified that the video is streaming, as well as individuals that agreed to be alerted when the originator of the video is streaming it live. All MBC User Community Members (originators/streamers and viewers) will incur charges from their mobile carrier when using 4G or LTE. The subject Mobile Broadcasting technology platform has applications for teenagers, college students, and young professionals who are a generation brought up online, and baby boomers that live a distance from their children/grandchildren who want to witness life experiences as they happen. Businesses that actively participate in Social Media and view online content as an important part of their marketing mix as well as businesses that want to use live streaming for training and development purposes also have broad applicable use of the subject Mobile broadcasting technology.

In a first embodiment a mobile broadcasting communication cloud is provided. Cloud based broadcasting is fully powered by the Internet Protocol (IP) backbone. Wi-Fi network users broadcast a live event IP streamed to a MBC Server. The MBC server is backed up by a high speed data network, which in turn broadcasts the live event to all MBC networks of users. Users can simply browse the channels and watch the live video feeds. Since this is entirely on IP protocol there is no need of network operator infrastructure or a broadcast multicast service center.

In another embodiment, a mobile broadcasting communication app is provided wherein a MBC User can simply open the MBC app and shoot a video and stream it live to other MBC users. If the users are not on Wi-Fi or do not have IP infrastructure the users can instead use the 3G or 4G network associated with their mobile device operator and stream the feed live to the MBC server. Since the live broadcast uses the mobile operator's backbone a separate MBC server authentication by mobile operator preferably is carried out.

Advantageously, the MBC platform is adapted to utilize either a wireless backbone or a dedicated network. Error correction technology, compression and validation software, such as that powered by the trade name Kencast, provides seamless and error free streaming with no loss of data tightly coupled with communication devices like TV, Tablets, Phones and PCs.

The subject MBC architecture is a multi-tier and multi layered and multi network driven architecture. The architecture is flexible to use either client side technology or client side network depending on how the client wants to use. For example is the end client user is in Wi-Fi can directly interact with the MBC server and avoid using mobile operator backbone. Alternatively if the user is not in Wi-Fi network but in normal 3G or 4G network can still use this solution using network operator's backbone.

The present disclosure provides a communications platform for a network and mobile devices for transmitting data over at least one network and/or to or between users of mobile devices and for receiving data from a server or a user for redistribution over at least one network or to other users.

The communication platform disclosed herein permits a user to interact with a multi-page application. In an embodiment, a web application server comprising Javaserver pages associated with a user (such as an individual, a government entity or a service provider) may receive a request from a user to generate a data transmission. On receipt of the request, the web application server may accordingly process the request and retrieve a page from the Javaserver pageflow. The user may then enter data in a query form on the page and submit it to the web application server. The server may then process the query form to generate a message in a page format. The user may request that the server distribute the generated message to one or more individuals or categorized users that meet a criterion or criteria. It will be understood that the server is capable of communicating with users may reside on the same network as a mobile device of a user.

The present disclosure further provides a communications platform for mobile devices for transmitting data (such as alert messages) to at least one mobile device user. In an embodiment, the communications platform comprises an alert server and an alert client. The alert server may be responsible for managing mobile device user profiles, alert campaign administration, alert messages encryption, and delivery of alert messages.

The alert client may be an application that resides on a user's mobile device. The client may be responsible for receiving alert messages sent by the alert server and may further perform specific functions on the mobile handset to insure that the alert message does not remain unnoticed or ignored.

In an embodiment, the alert server may include a software application that allows an administrator to manage or perform tasks associated with the communications platform, such as, but not limited to, alert campaign management, integration and updating of mobile device user databases, and the like. In an embodiment, the server includes at least one end-user database, such as a routing database system (RDBS) or a lightweight directory access protocol (LDAP) user profile repository. Any number of databases can be integrated with the alert server such that the alert server may access such databases to define a list of recipients (i.e., mobile device users) for a creation of an alert message campaign.

The alert server can send alert messages in mass quantities and permits an administrator to create future-date alert campaigns (for example, for transmission of alert messages on a predetermined future time, as opposed to on an as-needed basis.) A future-alert campaign can also be set to repeat itself on a specific date and time. The server may be capable of encrypting outbound alert messages via cryptographic protocols such as RSA® and elliptical curve cryptography. It will be understood that the alert client of the communications platform will be configured to decrypt any encrypted messages generated by the alert server

In an embodiment of the present disclosure, the alert client of the communications platform comprises a plug-in or application that is installed on a user's mobile device. In an embodiment, the client is a J2ME-based mobile application. It will be understood that the client application may also be Symbian-based, for example, or utilize any other language that is compatible with mobile phone operating system software. In another embodiment, the alert client comprises a plurality of applications, such as first application that is capable of recognizing an incoming cellular broadcast transmission and is further capable of opening a channel on a mobile device for receiving the transmission, and a second application that operatively communicates with the first application to receive and convert the transmission for display to a user on his or her mobile device.

The alert client application(s) may be installed via over-the-air methods to a user's mobile device for ease and convenience in installation. The client may run as a background process on the mobile device such that a user is not required to activate it prior to being able to receive alert messages from a server of the communications platform.

In an embodiment, the client is configured to receive an alert message that may be generated by the server (or may be uploaded to the server by a third party) and transmitted by the server. Upon receipt of an alert message, the client will notify the device user of the message. In an embodiment, upon receipt of a message, the client will activate the mobile device's “vibrate” function, activate a distinct ringtone that may be included upon an installation of the client, and open a full-screen popup message on the device's display screen, which message will include the contents of the alert message generated and/or transmitted by the server. The pop-up message will replace any image that was on the display screen prior to receipt of the alert message. In an embodiment, the ringtone (for example, a siren tone) activated by the client may sound continuously until the user deactivates the ringtone. The user will be able to return to the display screen's previous image by manipulation of his or her mobile device's display controls. Upon such action by the user, the client will transmit a return message to the server that indicates that the user has received the alert message.

In a first embodiment, a communications platform is provided. The communications platform comprises at least one server, a transport layer, a client, and at least one mobile communications device, wherein the client comprises at least one application operatively coupled to the at least one mobile communications device, the client being capable of communicating with the at least one server of the platform over the transport layer, the client being also capable of receiving a transmission from the at least one server over the transport layer, the client being further capable of displaying said transmission on the at least one mobile communications device upon direction from the at least one server, and the client being further capable of transmitting a return message communicating with the at least one server that a transmission has been displayed on the at least one mobile device, wherein the communications platform is not dependent upon a data carrier's network or carrier's transmission facility thereby providing an independent communication platform for distribution and transmission of data.

In another embodiment, a communications platform is provided comprising: at least one server, at least on transport layer, and at least one client comprising at least one application operatively coupled to the at least one transport layer and operatively coupled to at least one mobile communications device, the client being capable of communicating with the at least one server of the platform over the transport layer, the client also being capable of receiving a transmission from the at least one server over the transport layer, and the client being further capable of displaying said transmission on the at least one mobile communications device upon prompting from the at least one server.

In another broad embodiment a mobile cloud application system for a mobile communications platform is provided. The mobile cloud application system is adapted for use with a wireless interactive device capable of receiving and transmitting messages, accepting user interface input, and displaying messages on an electronic display, the mobile cloud application system comprising: at least one server, an Internet Protocol (IP) backbone transport layer for Wi-Fi connectivity, and at least one client comprising at least one application operatively coupled to the at least one transport layer and operatively coupled to at least one wireless interactive device, the client being capable of communicating with the at least one server over the transport layer, the client also being capable of receiving a transmission from the at least one server over the transport layer, and the client being further capable of displaying said transmission on the at least one mobile communications device upon prompting from the at least one server.

A communications method is further provided comprising the steps of: streaming at least one live broadcast from at least one wireless interactive device to at least one cloud with a server having error correction technology, compression and validation software, over a mobile cloud application system for a mobile communications platform comprising: at least one server, an Internet Protocol (IP) backbone transport layer for Wi-Fi connectivity, and at least one client comprising at least one application operatively coupled to the at least one transport layer and operatively coupled to the at least one wireless interactive device, the client being capable of communicating with the at least one server over the transport layer, the client also being capable of receiving the live broadcast transmission from the at least one server over the transport layer, and the client being further capable of displaying said transmission on the at least one mobile communications device upon prompting from the at least one server; and at least one other wireless interactive device being capable of streaming and displaying the live broadcast.

FIG. 1 illustrates an exemplary embodiment of an environment 100 in which various embodiments of the present disclosure may be practiced. The environment 100 includes a mobile device 102, an SMS Internet proxy server 104 (hereinafter referred to as ‘SMS server 104’), and an information network 106. Examples of the mobile device 102 may include a mobile phone, a Personal Digital Assistant (PDA) and the like. It will be evident to those skilled in the art that the information network 106 may be a network, such as the Internet, including a plurality of computing devices in a plurality of locations and capable of communicating with each other. The mobile device 102 is capable of communicating using SMS as a transport layer with the SMS server 104 over at least one of a wireless network and a wired network. The SMS server 104 is similarly capable of communicating with the information network 106 (and, in an embodiment, a web application server residing thereon) over at least one of the wireless network and the wired network. Examples of the wireless network may include a cellular network, a Wireless Local Area Network (WLAN) and the like. Examples of the wired network may include, but are not limited to, Ethernet, Local Area Network (LAN) and the like.

In another embodiment, the environment 100 includes a cell broadcast service (CBS) (not shown), and the mobile device 102 is capable of communicating using cell broadcast (CB) as a transport layer. In this embodiment, a server 104a and mobile device 102 will be coupled with the cell broadcast service. In such an embodiment, the server will generate and transmit an alert message to at least one cell broadcast entity (CBE) of the CBS. The CBE may then transmit the message to a Cell Broadcast Center (CBC) of the CBS for delivery of the message. The CBC may forward the message to at least one Base Station Controller (BSC) in a mobile network. It will be apparent that each BSC of a mobile network will control at least one mobile data transmission tower.

Upon receipt by the at least one BSC of an alert message, the at least one BSC will forward the message to one or more of the mobile towers associated with the BSC. The tower or towers receiving the alert message from a BSC may then broadcast the alert message on one or more of the dedicated frequencies, and mobile devices 102 configured with the client of the present disclosure will receive the message. In such an embodiment, transmission of an alert message may be limited to mobile device users situated in a distinct and specified geographical area.

The mobile device 102 preferably includes a browser 108 capable of displaying data, such as data in the form of an SMS message or cell broadcast message, a WAP application, an Instant Message, electronic mail, and Limited HTML Device integration.

Though the mobile device 102 as shown in FIG. 1 is depicted to include only the browser 108, it will be evident to those skilled in the art that the mobile device 102 may include components such as a processor, a number key pad, a display screen, and the like for performing regular functions of the mobile device 102.

In an embodiment, the SMS server 104 receives the request SMS message from a client or a user for generation of a data transmission and sends a generation request to the information network 106. The request may be sent using any of a Hypertext Transfer Protocol (HTTP), a Simple Mail Transfer Protocol (SMTP), a Real-time Transport Protocol (RTP), a Domain Name System (DNS), and the like. The SMS server 104 is further capable of receiving a response in the form of a data transmission generated by the information network from the information network 106. The response may be sent using any of a Hypertext Transfer Protocol (HTTP), a Simple Mail Transfer Protocol (SMTP), a Real-time Transport Protocol (RTP), a Domain Name System (DNS), and the like. For instance, if the SMS server 104 sends an HTTP request for the target URL to the information network 106, then the information network 106 sends an HTTP response for the HTTP request to the SMS server 104.

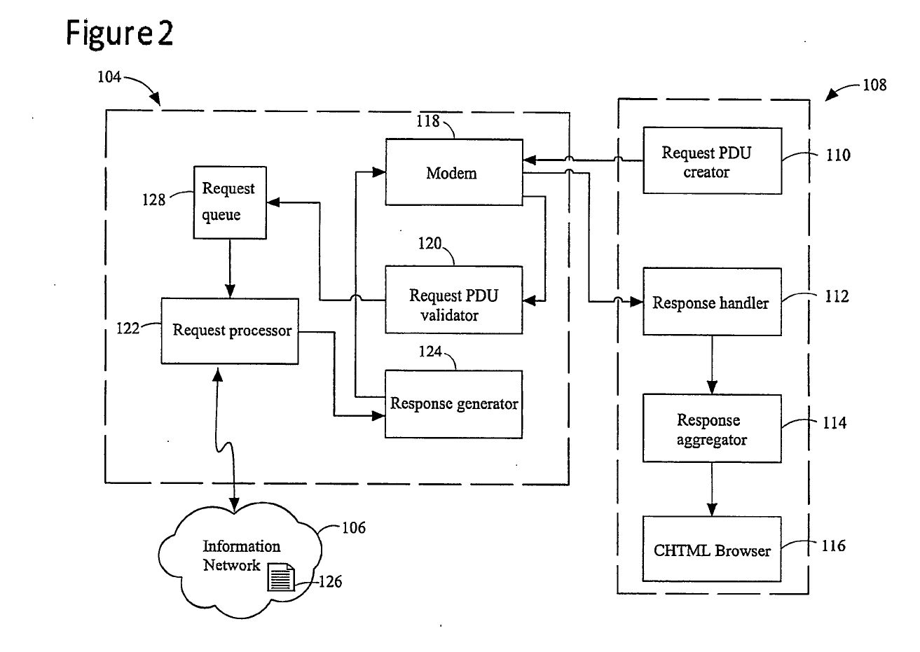

The SMS server 104 sends the response received from the information network 106 to the browser 108 in the form of at least one response SMS messages. The browser 108 receives the response using SMS as the transport layer and processes the at least one response SMS messages to generate the data transmission. The browser 108 is capable of providing the data transmission to a user interface (not shown) provided on the mobile device 102 for display purposes. The browser 108 and components thereof are explained in detail in conjunction with FIG. 2. In another embodiment, the server, operatively coupled with a cell broadcast entity, may send a message to a browser 108 of a mobile device 102 by way of cell broadcast as the transport layer.

In an embodiment, a user may request the data transmission, and the network may send the generated transmission to at least one user. In this embodiment the requesting user may request the generation of a message that is to be generated and transmitted to at least one user based upon at least one criterion associated with the at least one user that is to receive the transmission. In such an embodiment, the information network is capable of receiving at least one criterion in connection with data generation request. The information network will include a processing module that is capable of transmitting a generated response to only a distinct user or group of users that meet the criterion or criteria specified in a data generation request. In this embodiment, a user may request that an emergency message be generated and transmitted to a group of users that fall within a specified geographic criterion, for example.

FIG. 2 illustrates a block diagram of the browser 108 for receiving and displaying a data transmission providing access to the information network 106 to the user of the mobile device 102 in accordance with an embodiment of the present disclosure. The browser 108 includes a request Protocol Data Units (PDU) creator 110 (hereinafter referred to as ‘request PDU creator 110’), a response handler 112, a response aggregator 114 and a browser 116. The SMS server 104 includes a modem 118, a request PDU validator 120, a request processor 122 and a response generator 124. It will be apparent to one skilled in the art that the server will include the requisite components to facilitate communication with a cell broadcast entity.

A browser 108 of a first device 102 (not shown) generates a data transmission such as a media message 126. The request PDU creator 110 receives media 126 and generates a request PDU associated with the media. A PDU such as the request PDU includes control information, (optionally) a network address and data associated with the media. The mobile browser 108 sends the request PDU in form of a request SMS message to the SMS server 104. In an embodiment of the present disclosure, the request PDU creator 110 creates a plurality of request PDUs associated with a data transmission input by the client or user of the first mobile device 102. Accordingly, the mobile browser 108 sends the plurality of request PDUs in the plurality of request SMS messages to the SMS server 104. The request SMS message or the plurality of request SMS messages is received by the SMS server 104 using the modem 118. An example of the modem 118 is a Global System for Mobile Communications (GSM) modem. However, it may be apparent to a person skilled in the art that any other types of modems that are capable of establishing a communication link between the SMS server 104 and the mobile browser 108 for sending and receiving SMS messages may be configured in the SMS server 104, or between a server associated with a CBE and a mobile browser for sending and receiving cell broadcasts configured in the server.

The data transmission of the first device 102 received by the modem 118 is sent to the request PDU validator 120. The request PDU validator 120 validates the request SMS message to identify the data transmission generated by a client or user of the first mobile device 102. More specifically, the request PDU validator 120 reads the request PDU present in the data transmission to identify the data transmission, and, optionally, any criteria and or/distribution lists or instructions contained therein. The request PDU validator 120 thereafter places the data transmission of the first device 102 in a request queue 128. The request queue 128 may include a plurality of data transmissions received from a plurality of mobile devices, such as the mobile device 102, communicably connected with the SMS server 104.

The data transmission present in the request queue 128 is received by the request processor 122 based on, for example, an order of the plurality of data transmissions in the request queue 128. In another embodiment, the request queue may reorder data transmissions for processing based on characteristics of the transmissions, such as, for example, keywords in a transmission, the user that generated a transmission, or other identifying characteristics. The request processor 122 is capable of sending a message generation request based on the data transmission to the information network 106 for obtaining a media message 126 for distribution to a browser 108 of at least a second mobile device 102 (not shown). In an embodiment of the present disclosure, the message generation request for the message may be sent using an HTTP protocol to the information network 106. Thus, the request send to the information network 106 may be an HTTP request. It may be apparent to a person skilled in the art that the request processor 122 may employ other protocols known in the art such as a Simple Mail Transfer Protocol (SMTP), a Real-time Transport Protocol (RTP), a Domain Name System (DNS) and the like, for sending the URL request associated with the target URL to the information network 106. In an embodiment of the present disclosure, the request processor 122 may include a module to initiate the URL request to the information network 106.

The information network 106 provides a response for the request, i.e. the message generation request received from the request processor 122. In an embodiment of the present disclosure, the information network 106 sends an HTTP response for the HTTP request received from the request processor 122. The response may include contents of the media message 126 requested by a client or user of the first mobile device 102. The request processor 122 receives the response and sends the response to the response generator 124. The response generator 124 converts the response into multiple response SMS messages. More particularly, each response SMS message of the multiple response SMS message may include a part of the contents of the media message 126. In an embodiment of the present disclosure, the response generator 124 creates an SMS response beam (hereinafter referred to as ‘response beam’) using the multiple response SMS messages associated with the message 126. It will be apparent to a person skilled in the art that the response generator 124 is configured to generate a plurality of response beams for media message requested by the user of the mobile device 102.

In another embodiment, the response generator 124 converts the response into one or more CB transmissions.

The response generator 124 sends the response beam, e.g., at least one response SMS message or at least one response CB transmission, to at least one of the first and second (and, optionally, additional mobile devices) mobile device 102 through the modem 118. More specifically, the modem 118 transmits each response SMS message of the response beam to the browser 108. The response handler 112 receives the each response SMS message or response CB transmission and sends the response beam to the response aggregator 114. In the event of a plurality of messages, the response aggregator 114 aggregates or merges the contents included in the multiple response SMS messages or multiple CB transmissions. In an embodiment of the present disclosure, the response aggregator 114 may be further configured to arrange the multiple response SMS messages or multiple response CB transmissions within the response beam. Subsequently, the response aggregator 114 concatenates the multiple response SMS messages into a single response SMS message, or the multiple response CB transmissions, into a single CB response message (hereinafter referred to as “response message”).

More particularly, the response aggregator 114 combines the contents of the plurality of messages to form the response message. The response aggregator 114 sends the response message to the browser 116 for displaying the content present in the response message to the user. In an embodiment of the present disclosure, the response aggregator 114 may generate the response message in a (Hyper Text Markup Language) HTML format, i.e., a HTML message. The HTML message may be send to the browser 116 such as a HTML browser to generate an HTML page containing the contents present in the HTML message. The HTML page may be displayed as a media message 126 to the user through a display screen of the mobile device 102. It will be apparent to a person skilled in the art that the response aggregator 114 may generate the response message in the form of any other format known in the art such as an XHTML format, an WML format, an SMS format and the like and send the response message to any browsers known in the art such as a XHTML browser, a WML browser, an SMS browser and the like, to generate the data transmission to be displayed to the user. In an embodiment, the response message or data transmission may include a command that activates a mobile device's message receipt signal (such as a ringtone or a vibrate function).

It will be evident to those skilled in the art that each components of the mobile device 102 such as the request PDU creator 110, the response handler 112, the response aggregator 114 and the browser 116; and each component of the SMS server 104 such as the request PDU validator 120, the request processor 122 and the response generator 124 may be implemented as a hardware module, a software module, a firmware module, or any combination thereof. Furthermore, it will be obvious to those skilled in the art that the browser 108 and the SMS server 104 may include requisite electrical connections or other connections for communicably coupling the various components of the browser 108 and the SMS server 104, respectively.

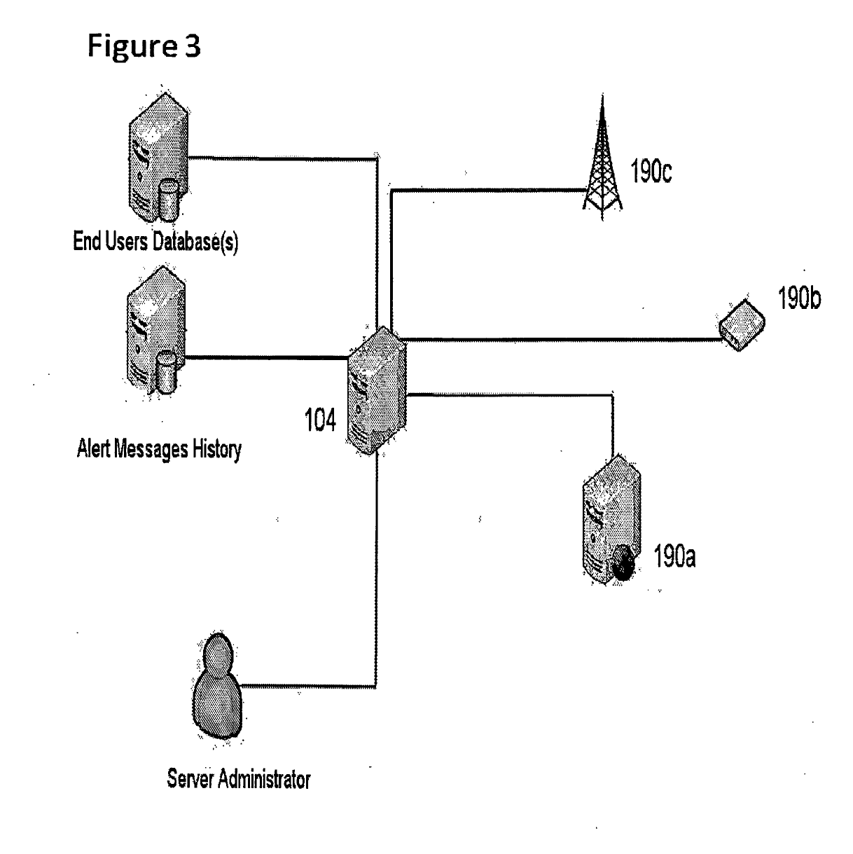

Referring now to FIG. 3, in another embodiment, a communications platform for transmittal of messages is provided. In such an embodiment, for transmittal of an alert message from an alert server 104 to a user, the server may utilize one or more SMS gateways 190. Further, the SMS gateways may be web-based 190a, a Global System for Mobile Communications (GSM) modem gateway 190b, or a Short Message Service Center gateway 190c. Moreover, the server may relay alert messages through a plurality of protocols such as short message peer-to-peer (SMPP), for instance, to a Short Message

Service Center gateway 190c, AT commands, for instance, to a GSM model gateway 190b, hypertext transfer protocol (HTTP), simple object access protocol (SOAP), for instance, to a web-based SMS gateway 190a, or any other protocol supported by one or more of the SMS gateways 190.

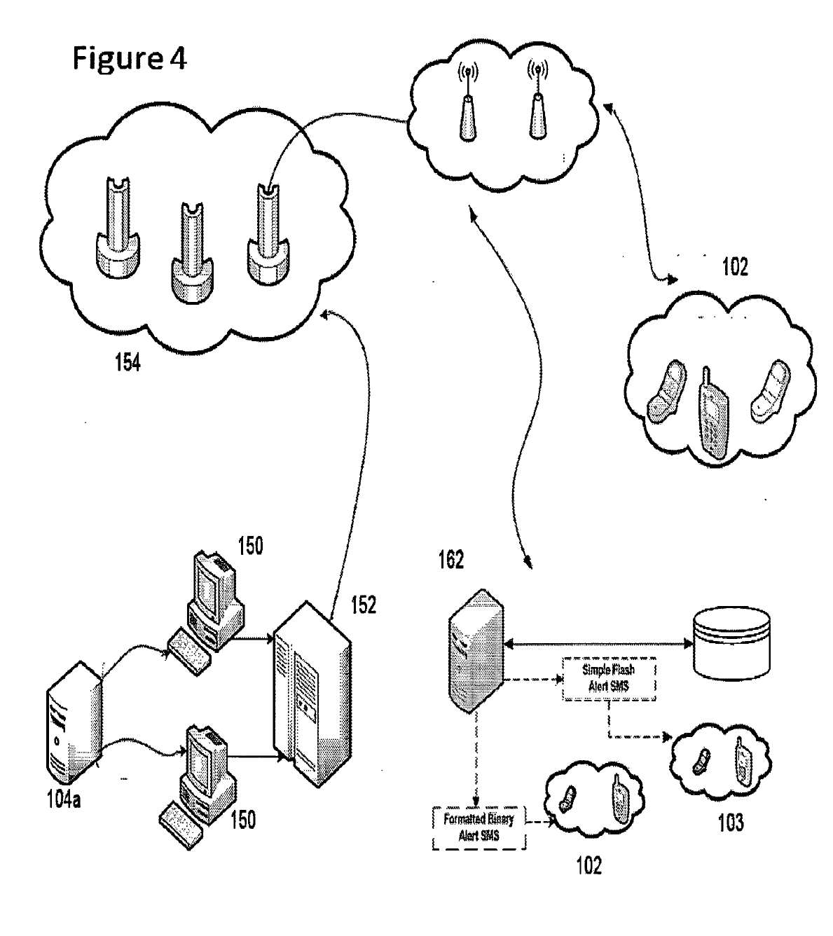

In another embodiment, referring now to FIG. 4, transmittal of a message, such as an alert message, from the server to the alert client may occur via a dedicated emergency frequency or set of frequencies, such as a frequency located in the 800 MHz band. In such an embodiment, the client further comprises a scanner that will search for messages transmitted by the server on the dedicated frequency or frequencies. In this embodiment, the server 104a and client will be coupled with a cell broadcast service (CBS). In such an embodiment, the server 104a will generate and transmit a message such as an alert message to at least one cell broadcast entity 150 (CBE) of the CBS. The CBE 150 may then transmit the message to a Cell Broadcast Center 152 (CBC) of the CBS for delivery of the message. The CBC 152 may forward the message to at least one Base Station Controller 154 (BSC) in a mobile network. It will be apparent that each BSC 154 of a mobile network will control at least one mobile data transmission tower.

Upon receipt by the at least one BSC 154 of an alert message, the at least one BSC will forward the message to one or more of the mobile towers 156 associated with the BSC. The tower or towers 156 receiving the alert message from a BSC 154 may then broadcast the alert message on one or more of the dedicated frequencies. Mobile devices 102 configured with the client of the present disclosure will receive the message, and the alert message will display on the receiving mobile device as described in conjunction with FIG. 3.

It will be understood that the server may, through the CBS, direct transmission of an alert message to mobile data transmission towers in a particular locality or localities, so as to transmit an alert message only to mobile device users in a particular locality or localities. In such an embodiment, the communications platform disclosed herein manages the resources of a mobile carrier's network or other communications network by limiting the transmission of messages and distribution of data to a distinct group of recipients, and limits the consumption of network capacity by preventing the sending of messages to unintended recipients.

In yet another embodiment, referring again to FIG. 4, an alert communications platform further comprises a mediation server 162, which server may receive alert messages transmitted over the CBS. The mediation server may be coupled with a database 164 similar to the database or databases described above in connection with the alert server of the communications platform. The database or databases 164 may include identification of a plurality of mobile device users, as well as an indication of whether a user of the plurality of users has installed the client on his or her mobile device. Based on this indication, the mediation server may format an alert message received from the alert server for transmission to a particular user or users. In the event that a user's mobile device 52 is not configured with the client of the communications platform, the mediation server may convert an alert message to an SMS or MMS format before transmitting the message on to such a user so that the user can receive the alert and view the contents of the alert. In the event that a user's mobile device 102 is configured with the alert client, the mediation server 164 may transmit the alert message without any such conversion.

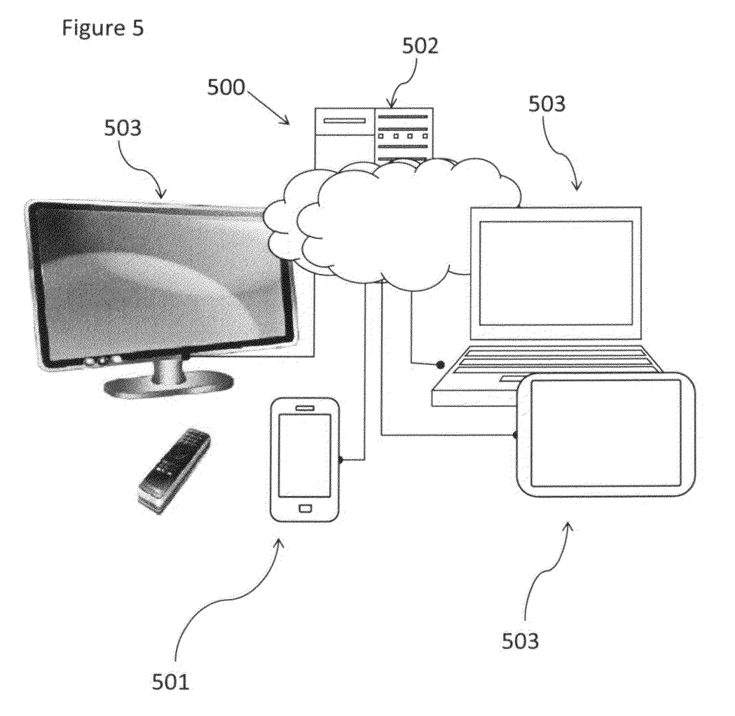

FIG. 5 illustrates an exemplary embodiment of an overview of the MBC platform shown generally at 500 showing a cloud based broadcasting solution fully powered by IF backbone. A user client device 501 via the originating client device (Mobile Phone or tablet) records, downloads and/or displays live video. Device 501 may be connected to a Wi-Fi network that streams the live event to the MBC server 502. Alternatively, device 501 may be connected to a 3G, 4G LTE network. Device 501 streams the live video to the MBC Server 502. MBC Server 502 is backed-up by a high speed data network and broadcasts the event to all MBC network users via multiple devices 503 associated with user clients and/or other third party non-client users that have submitted request for live video feed. MBC users can simply browse the channels and watch the live video feeds.

The entirety of the broadcast is on IP protocol and therefore there is no need of network operator infrastructure or a broadcast multicast service center. The receiving devices 503 open the MBC app of the subject MBC platform and architecture and preferably go to a channel providing the ability for the devices 503 to display the live broadcasting of the event on that specific channel. The MBC platform provides an online photo-sharing, video-sharing and social networking service with video capability.

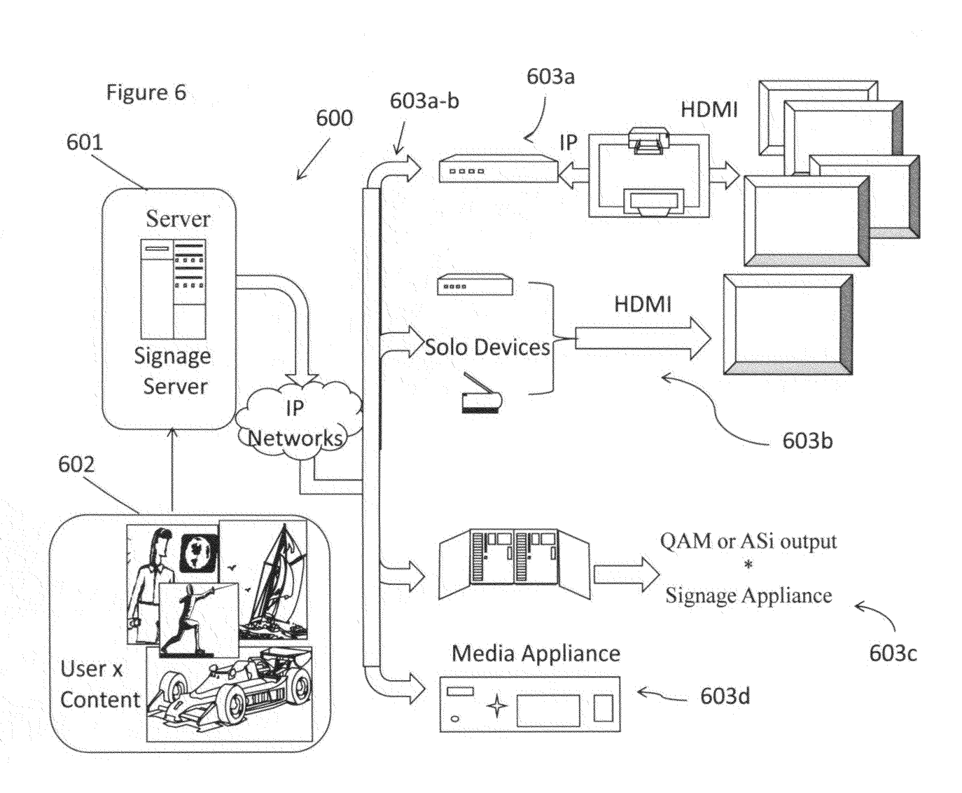

FIG. 6 illustrates an exemplary embodiment of an overview of the use of a server 601 with error correction technology, compression and validation software integration, shown generally at 600. Error correction technology, compression and validation software, such as that powered by the trade name Kencast, is integrated in server 601 to provide seamless and error free streaming with no loss of data adapted for tightly coupled with communication devices like TV, Tablets, Phones and PCs. The subject innovative and sophisticated MBC system uses either wireless backbone or a dedicated network. With error correction technology, the network broadcast is seamless and error free with no loss of data. Streaming of live video over the Internet for a user's community of users to see from anywhere in the world, at any time, on any device (PC, laptop, iPad, iPhone, Smartphone) is provided by way of the MBC platform.

Server 601 includes error software, such as servers sold under the trade name Fazzt Enterprise Server Software. User x has user content 602 streamed to server 601. Server 601 streams the live broadcast through IP Networks to user devices/venues 603a-n. User venue 603a includes a signage appliance, such as those sold under the trade name EdgeSpan, for storing and forwarding live video protected with software technology, such as that under the trade name Fazzt FEC and streams data via IP through Multicast LAN to IPTV STB and/or player s/w which in turn HDMI streams the broadcast to connected LCD/Plasma Screens, Projectors, etc. User venue 603b includes solo devices that HDMI stream broadcasts to a connected LCD/Plasma Screen, Projector, etc. User venue 603c includes appliance with video channel, such as that sold under the trade name EdgeSpan 3U, which transmits broadcast via QAM or ASi output for digital playout on TV similar to user venue 603a. User venue 603d provides streaming directly to a media appliance, such as the likes sold under the trade name Tempo.

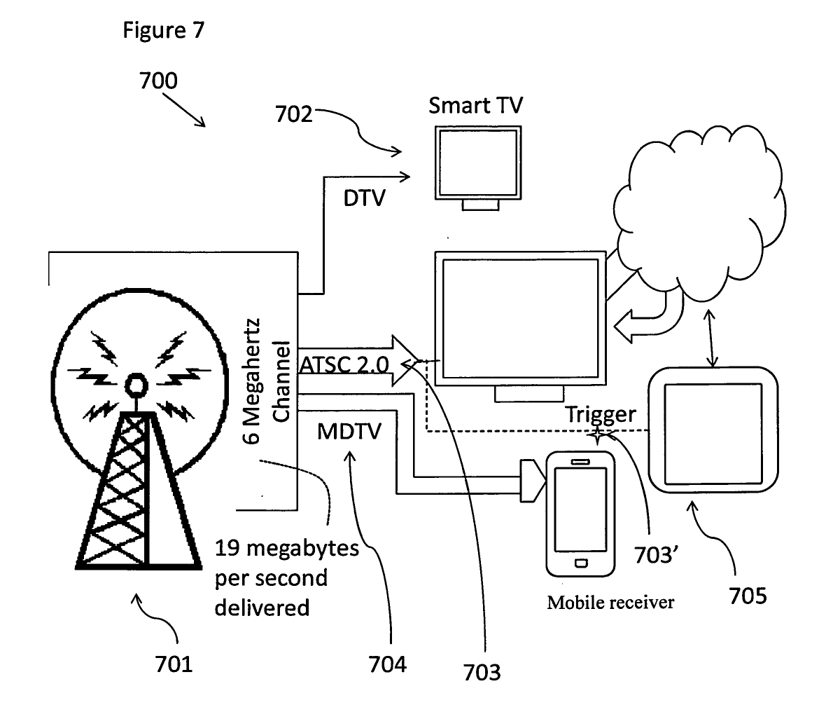

FIG. 7 illustrates a block diagram of an exemplary embodiment of the MBC platform architecture, shown generally at 700. MBC platform architecture is a multi-tier and multi layered and multi network driven architecture. The architecture is flexible to use either client side technology or client side network depending on how the client wants to use. For example, if the end client user is on a Wi-Fi network he/she can directly interact with the MBC server and avoid using a mobile operator backbone. Alternatively, if the user is not on a Wi-Fi network but on a normal 3G or 4G network, he/she can still use the MBC server by using the network operator's backbone. Antennae or satellite 701 delivers data via 6-megahertz channel to DTV 702, ATSC 2.0 fixed “smart” receivers 703 and mobile devices, and MDTV 704. Fixed “smart” receivers 703 store data locally for interactive graphics and on-demand shows and ATSC 2.0 triggers mobile receivers of digital devices, such as tablets, mobile phones, etc., for data storage and live streaming. Triggers 703′ are in the broadcast stream integrating Internet services with live programming at 705.

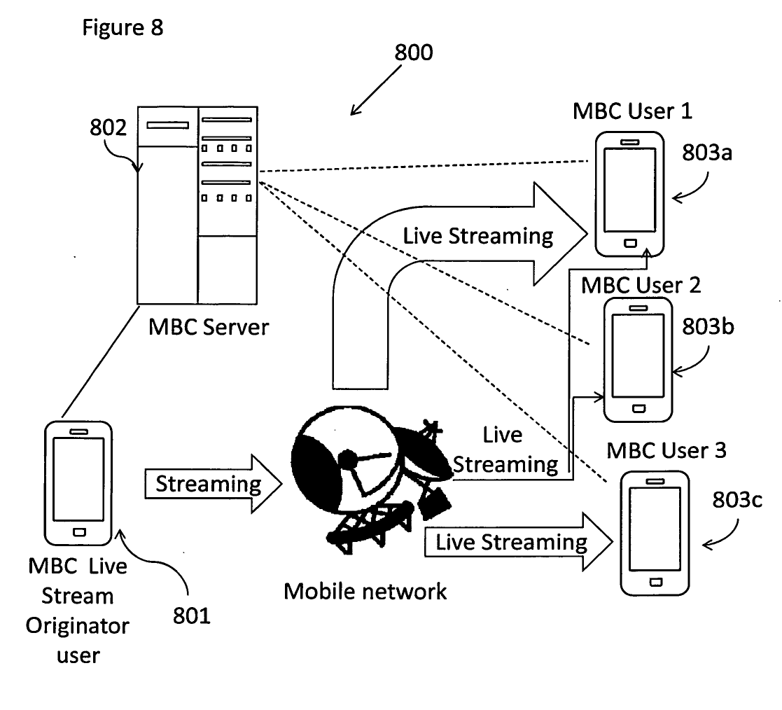

FIG. 8 illustrates a block diagram of an exemplary embodiment of the MBC platform architecture, shown generally at 800. MBC platform architecture is a multi-tier and multi layered and multi network driven architecture. MBC live stream originator user 801 utilizes a MBC App to stream content to MBC Server 802 for live streaming of content of originator user/client device 801 over the Internet to MBC users 1-n, 1-3 in this case, shown at 803a, 803b and 803c. Alternatively, originator user 801 can stream the live broadcast through mobile networks to client devices of MBC users 1-n, 803a, 803b and 803c. Originating client device (Mobile Phone or tablet) 801 is connected to 3G, 4G LTE network and streams the live video to MBC Server 802. Server 802 streams live video to multiple client devices of users 803a-803c that have submitted a request for live video feed. The receiving devices of users 803a-803c open the MBC app and go to a specified channel and watches/listens the live broadcasting of the event on that specific channel.

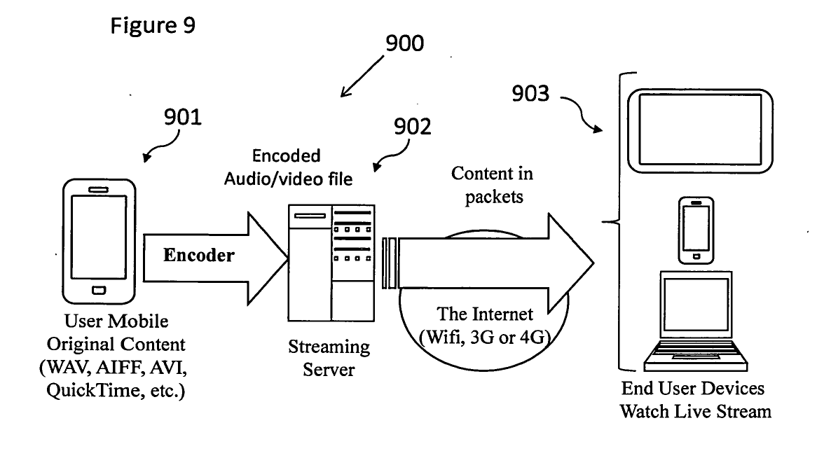

FIG. 9 illustrates a schematic view of the MBC platform content, shown generally at 900. Original live video streams are taken (point-and-shoot) by a member of the MBC User Community on a digital device, such as a Smartphone, cell phone or tablet, shown at 901. User Mobile Original Content (WAV, AIFF, AVI, QuickTime, etc.) is encoded and the encoded audio/video file is transmitted to the streaming server 902. Content in packets is transmitted over the Internet to End User Devices so that the end users, shown at 903, can Watch Live Stream of the video streamed or transmitted by the user at 901 on their digital device, such as a Smartphone, cell phone or tablet. Through use of the subject MBC platform, the maker or originator of the video stream/MBC user broadcasts it live to members of the MBC User Community that either agreed to receive video streams from that user or are tagged (identified) in the video. Public content channels (i.e. available online such as TV, radio, and news programs) are also accessible on the MBC Network via 4G or LTE mobile access.

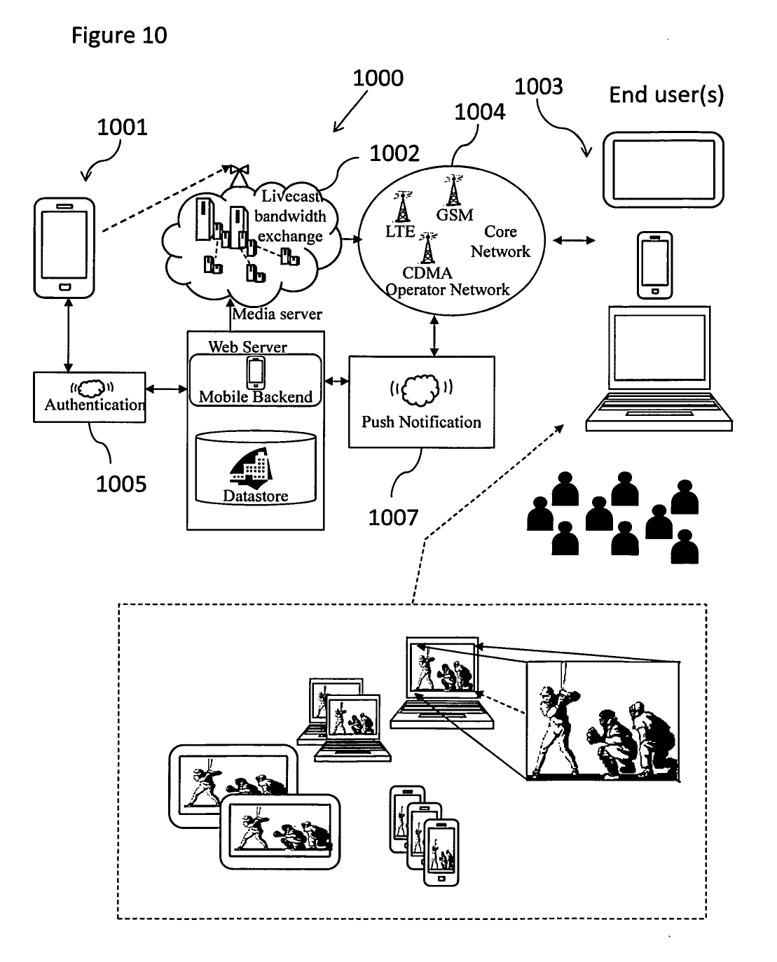

FIG. 10 illustrates a schematic view of the MBC platform server data flow from a first user/user taking/streaming video or content to other users who are identified to view the video or content, shown generally at 1000. MBC User streams media feed at 1001. MBC User streams media feed 1001 usage data whereupon user access and authentication is verified at 1005. A notification 1007 is sent to connections of available live video streams, as well as streaming and viewing live videos. A live cast system receives the feed and propagates it to authorized viewer end users at 1002. Live cast enables live video streaming directly from a cell phone, mobile Internet device, tablet, PC, or MAC to anyone connect to the Web. Coupled with GPA-enabled mobile devices, it may add detailed location data within each frame of the video stream. Video is broadcast via 3G/4G wireless network at 1004. The content is shared via live stream with colleagues on phone or computer/end users/viewers at 1003. Error correction technology, such as that sold under the trade name Kencast, can be utilized to make the live stream seamless and error free with no loss of data, eliminating or reducing buffering. Error correction technology can be used with communication devices such as Smartphone, laptops, tablets, PCs or smart TVs, or other devices having 4G or LTE mobile access, eliminating or reducing buffering. Quality of the live stream is dependent on two factors: compression rate (speed and quality) and network speed. MBC is using error correction technology so that the video stream will be of high quality and speed, as well as error free.

Preferably, the live stream is recommended to be carried out in HD mode to users on a high speed network (4G/LTE). In a first embodiment the MBC technology is utilized in conjunction with major mobile networks, however the MBC technology alternatively may be utilized on Wi-Fi without association or use with major mobile networks. Optionally, the MBC technology platform may include an option to upload and save videos. In one embodiment, videos can be shared on a social media. Live chat features may be incorporated into the platform. Location details are optionally provided by the MBC platform. In addition, the originator use can limit the number or allowed viewers, and/or select specific viewers only as well as specify whether or not the selected viewers can share the video on a social media venue. For security, RSA Security with 128 bit encryption and/or MD5 can be used, and the server web app secured by SSL. For mobile security a secured cloud service is preferably implemented.

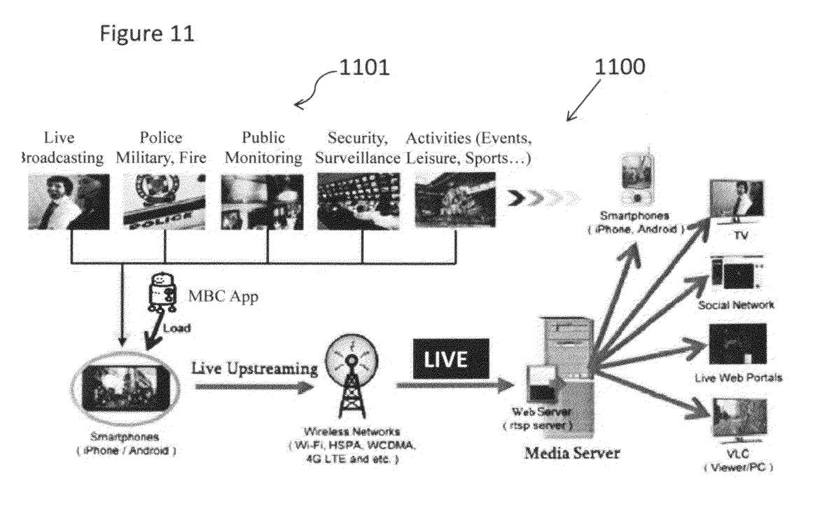

FIG. 11 is a schematic view of flow of data (content) from different sources through the MBC network, shown generally at 1100. MBC App 1101 provides live streaming and access to any number of private (MBC user originated) or public (TV, radio, news networks, etc.) channels made available on the MBC Network. MBC Community Members can browse available channels to watch video feeds. Accordingly, MBC eliminates the need to download access and maintain multiple apps or websites to view content or 4G or LTE mobile access.

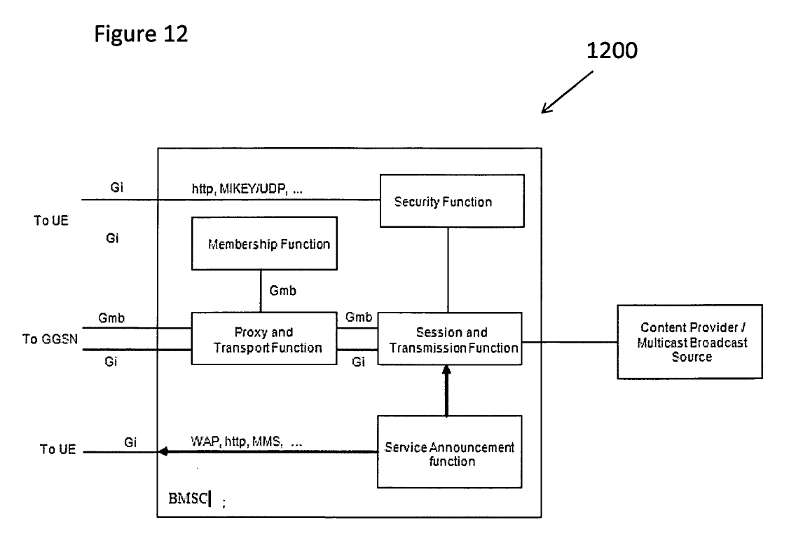

FIG. 12 is a schematic view of the broadcast multicast service center (BMSC) of the MBC network, shown generally at 1200. The terms broadcast and multicast are similar for point-to-multipoint (PTM) communication where content is simultaneously transmitted from a single source to multiple destinations. The term broadcast refers to the ability to deliver content to all users. Examples are radio and TV programs which are broadcasted over the air (either terrestrial or via satellite) and over cable networks. Multicast refers to programs or services that are delivered only to users who have joined a particular group and requested access to the content. For example MBC Community Members can request content from fellow members or from public channels (i.e. sports, news, weather, cartoons, etc.) available on the MBC network. BMSC is a network component added to provide a number of specific functions.

BMSC performs the following five major functions. Firstly, BMSC provides security functions: Integrity and/or confidentiality protection of MBMS data, distributing MBMS keys (Key Distribution Function) to authorized community members. Secondly, BMSC provides session and transmission functions: Provides session scheduling, session identifier, allocates TMGI and transport as—associated parameters (QoS and Service Area), initiates and terminates MBMS bearer resources, and sends MBMS data; authenticates and authorizes external sources. Thirdly, BMSC provides service announcement functions: Provides media and service description towards community members, initiates service announcements via PUSH/URL/SMS/SMS-CB etc. Fourth, BMSC provides proxy and transport functions: Proxy agent for signaling over Gmb reference point; generates charging records for the content provider. The BMSC Proxy and Transport Function also handle instances when the BMSC functions for different MBMS services are provided by multiple physical network elements. Routing of the different signaling interactions is transparent to the GGSN. Fifth, BMSC provides membership functions: Provides authorization, subscription data and generates charging records. In addition, all signaling or control-plane functions between the BMSC and the GGSN are at the Gmb reference point, and all data or bearer-plane functions are at the Gi reference point.

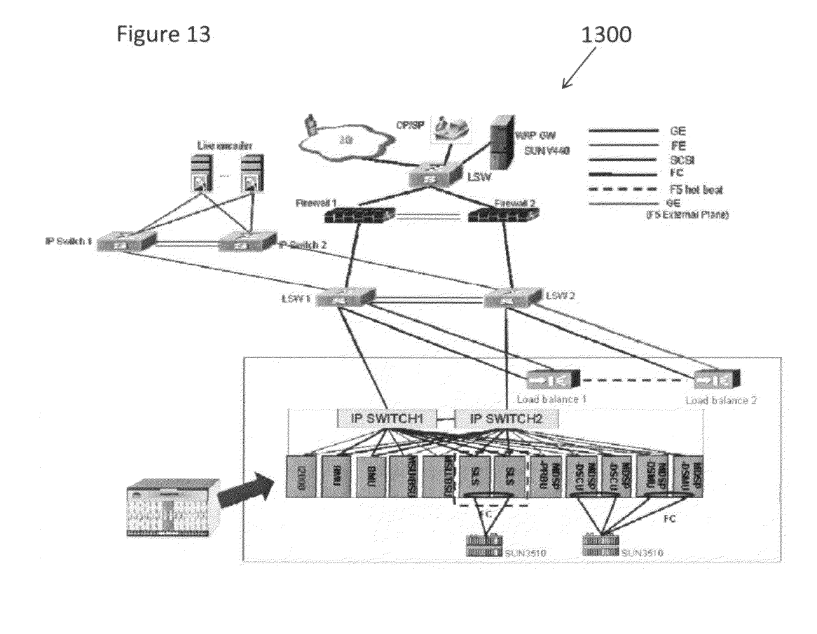

FIG. 13 is a schematic view of the BMSC physical architecture, shown generally at 1300. The BMSC architecture is utilized with initial supported devices, including Smartphone (such as those sold under the trade names iPhone, Android, Windows, etc.), Tablets (such as those sold under the trade names iPad, Android, Windows, etc.) with 4G or LTE support (Wi-Fi or 3G as an alternative), and Smart TVs (such as those sold under the trade names Apple, Google, Android, Microsoft). Supported operating systems of the BMSC architecture include iOS, Android (all variations) and Microsoft Windows 7x and 8x. Network specifications of the BMSC architecture include 4G, LTE, 3G, IP, HSPA, 802.11a/b/g/n, etc. Operating networks of the BMSC architecture include GSM and CDMA. The operating backbone includes Kencast error correction technology.

Device specifications contemplated for operation of the BMSC include Smartphone, 64-bit architecture, arm-7 processor or Intel processor, and at least 40x processor speed. The streaming resolution of the BMSC architecture provides for video compression with H.264 algorithm with rendering in HD, full HD and ultra HD (high speed networks). Technology of the BMSC architecture utilizes 302i, Error Correction, 3^{rd} degree piggy backing data channel.

The BMSC architecture and App features provide the several unique functions. Through use of the BMSC architecture users are able to access live videos, as well as videos from major networks—TV, radio, etc. from one app. An alert feature of a live stream to a connection is provided to alert users to access live videos, which are shown in high quality video TV-studio quality. Access to the live streaming video is provided through 4G or LTE mobile network. Error Correction Technology is utilized, such as that provided under the trade name Kencast, designed for optimal stream quality and accelerated delivery speed. Buffering is thusly limited or eliminated. Multiple Uses are provided by the BMSC platform, so that everyday consumers can use the Mobile Broadcast Network to stream their life experiences in real time. It can also be used commercially for fee based video streaming to paid viewers. Bandwidth may be increased using acceleration technology, including for example that sold under the trade name Blazeband™. Emergency Broadcasting System implementation may be provided wherein an alarm with a short message cell broadcast streams live emergency broadcast video and/or audio.

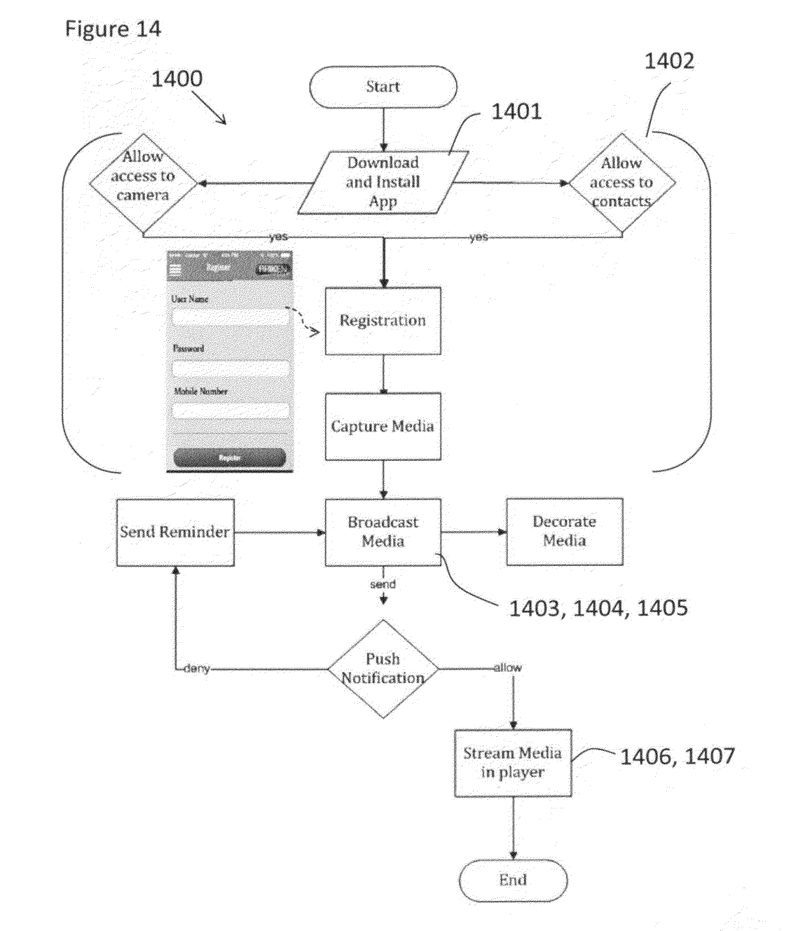

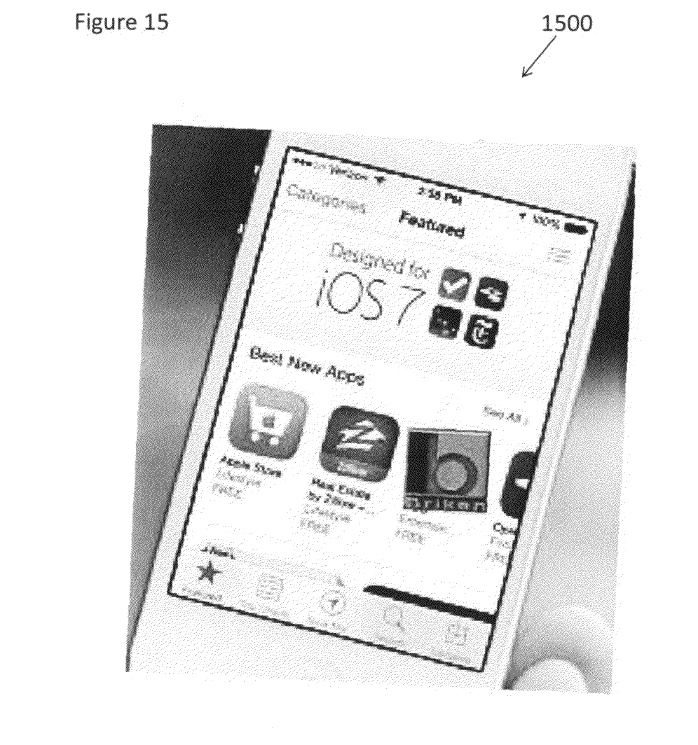

FIG. 14 illustrates a flow chart of an exemplary embodiment of the MBC flow of client application, shown generally at 1400. FIGS. 15-21 illustrate snap-shots of screen shots for each of the respective steps of the MBC flow diagram of FIG. 14. The purpose of the client application is to recognize broadcasts sent from the MBC Server. Client application resides as an app in the client side digital devices, including for example Smart Phones (such as those sold in association with the trade names iPhone, Android Phones, Windows), Tablets on Wi-Fi or 3G or 4G (such as those sold in association with the trade names iPad, Android Tablets, Windows 8 PCs and Windows Surface Or Windows Tablets), and Smart TVs (such as those sold in association with the trade names Apple TV, Google TV, Android powered smart TVs and Microsoft IP TVs). The operating systems at the client side include iOS, Android (all flavours) and Microsoft Windows 7.x and 8.x. The server application resides in cloud.

In an exemplary embodiment the MBC App includes an alarm that sounds with short message cell broadcast for emergency alert only. Once the notification is acknowledged by the recipient, the application will respond by sending a message to the recipient's SMS inbox. Essentially, the emergency notification will be copied and saved to the SMS inbox. The application will then send a text message, announcing the receipt of the emergency notification, via SMS, to the MBC server.

Referring to FIGS. 14-21, at step 1 at 1401 the client MBC App/application loads into the user's mobile digital device from a respective app store. Alternatively the client MBC App is also available on the MBC server directly for free download by users. From the network side, intelligent network service (IN Service), the app can also be downloaded by OTASP through a short code. A representative screen snap-shot of the app download is shown in FIG. 15 at 1500.

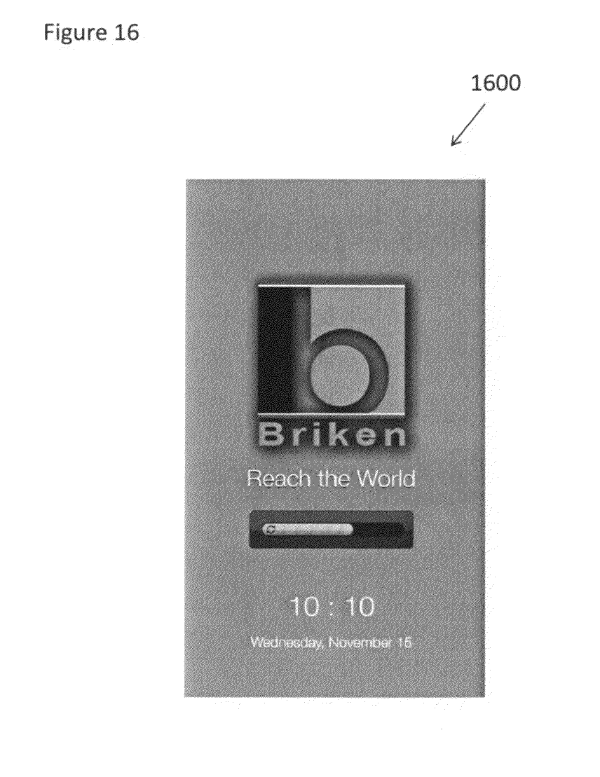

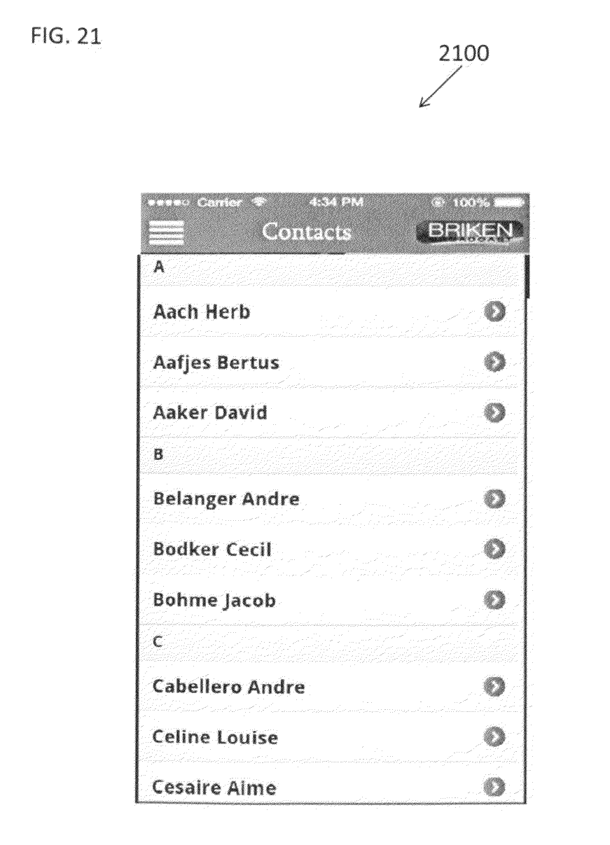

At step 2 at 1402 the app is uploaded on the device and displays a logo and licensing agreement (for the first time). A representative screen snap-shot of a sample logo and license is shown in FIG. 16 at 1600. The user registers with the MBC app. Information provided includes First Name, Last Name, Email, Phone number and password. The MBC App gives an alert “MBC wants to access your address book to identify other MBC users.” User clicks Yes or No. MBC app identifies all contacts that are registered with the MBC app and provides list to user. FIG. 21 shows a screen snap shot of a list of contacts at 2100. The user chooses “Accept/Don't Accept” for each MBC user on the list provided. If a user sends a live stream, the receiving user gets a “push notification” saying that “User A wants to stream an event. Do you wish to View?” Upon acceptance, the stream opens in MBC Video Player.

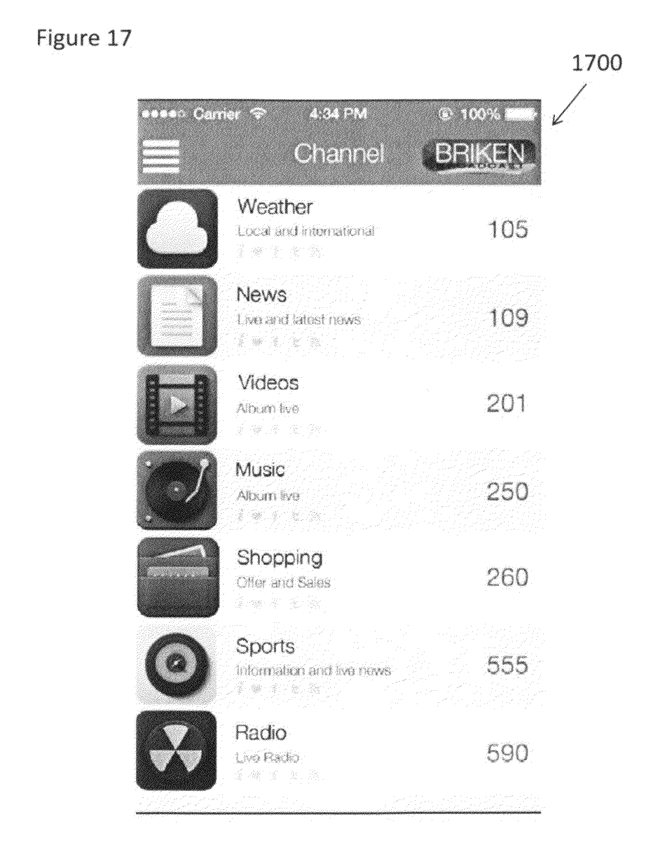

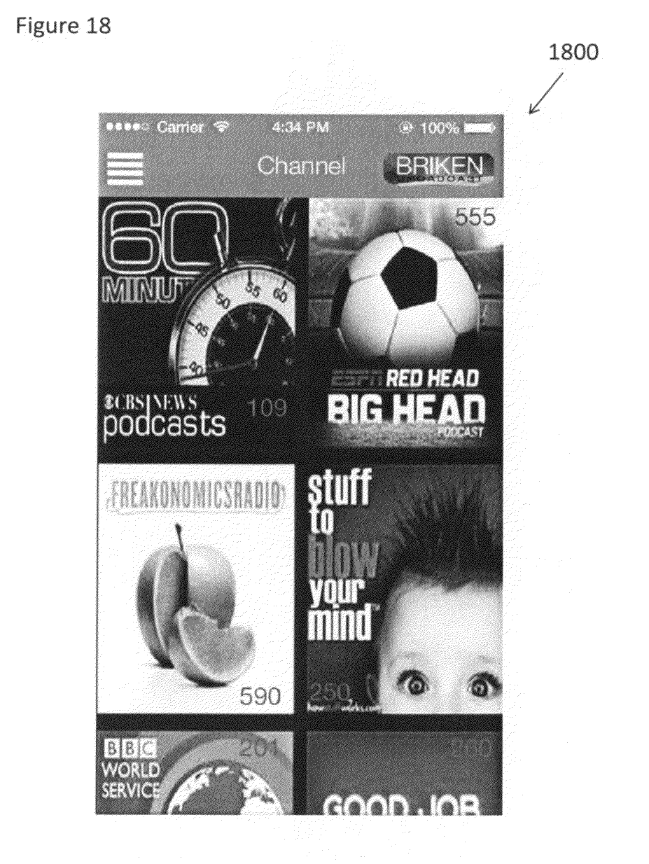

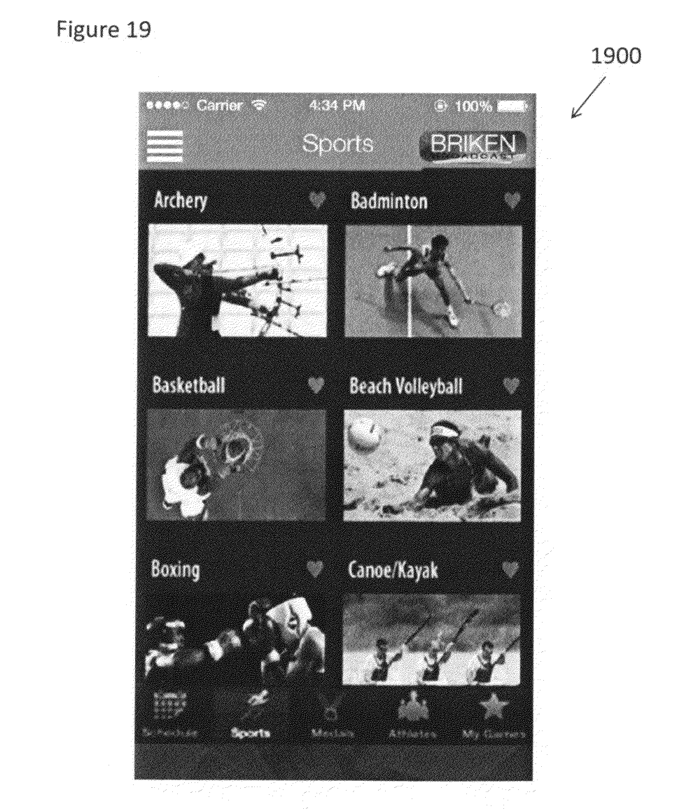

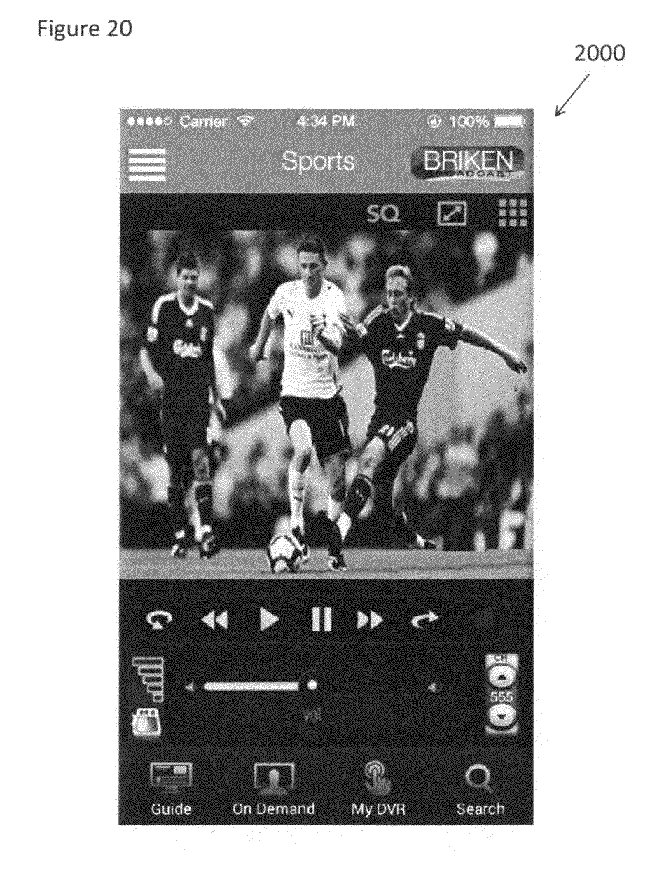

Continuing with FIGS. 14-21, at step 3 at 1403 the application includes a feature that allows broadcast channels on the handset to be tuned from the MBC server and the broadcast centre. At step 4 at 1404 the application will include a feature screen that allows the handset's owner to manually tune to a requested broadcast channel. The user will be able to view a list of available broadcast channels and use the screen capabilities on the handset to select and tune to any of these channels. A representative screen snap-shot of the client application is shown in FIG. 17 at 1700. At step 5 at 1405 the user selects the channel menu and a live tile based channel screen will be displayed in the app. A representative screen snap-shot of the channel menu is shown in FIG. 18 at 1800. At step 6 at 1406 upon selection of a particular channel all categories of feeds in that channel will be displayed to the user for final selection. A representative screen snap-shot of the channel feed is shown in FIG. 19 at 1900. At step 7 at 1407, the user selects a live feed so that he/she can watch the live broadcast of that event. A representative screen snap-shot is shown in FIG. 20 at 2000.

Upon installation of the Application, users are preferably shown a three dimensional red dot, that will serve as the decal/logo for the application. The object will appear on the display of all targeted Smartphone devices. Upon selection of this decal as a way of entering the BMC application, the red decal will blink red once, span to a full white screen, and show the initial World load screen of the BMC app. User Account Creation is initiated Upon Initial Login. Upon initial user login, users will be prompted by a transparent rectangular figure that will appear directly in the center of the display. This rectangular box will ask for a username, email (for user verification) password, and the option of always remaining logged in. The rectangular box will then swipe left once users have completed the prompts. The box will fade, and the display will swipe right to the next white display screen. A user login live stream load screen with appear prior to login (after entering information for initial login) users will be shown a live stream load screen, that will show a live stream image from various locations worldwide. Users are shown a variety of locations, and should not be shown the same live stream image upon login.

In use, the communications platform described herein enables transmission and receipt of data that is independent of access provided by a mobile device's service carrier or pursuant to a carrier's data plan. A user of the platform may request generation of a data transmission with particular content and obviate dependence on a transmission or data format that is offered by a user's carrier. Furthermore, the disclosure enables mobile devices that do not include WAP browser or are not capable of sending and receiving multimedia messages to still access data in a variety of formats. Moreover, in the instance of transmission of data by way of a CBE, the system allows data to be targeted towards and received by mobile device users in a specified and/or limited geographical area or areas.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A communications platform, the communications platform comprising at least one server, a transport layer, a client, and at least one mobile communications device,
wherein the client comprises at least one application operatively coupled to the at least one mobile communications device, the client being capable of communicating with the at least one server of the platform over the transport layer, the client also being capable of receiving a transmission from the at least one server over the transport layer, the client further being capable of displaying said transmission on the at least one mobile communications device upon direction from the at least one server, and the client being further capable of transmitting a return message communicating with the at least one server that a transmission has been displayed on the at least one mobile device, wherein the communications platform is not dependent upon a data carrier's network or carrier's transmission facility, thereby providing an independent communication platform for distribution and transmission of data.

2. The communications platform of claim 1, wherein the at least one server comprises a short message service internet proxy server.

3. The communications platform of claim 1, wherein the transport layer comprises short message service.

4. The communications platform of claim 1, wherein the transport layer comprises cell broadcast service.

5. The communications platform of claim 1, wherein the at least one server further comprises a mediation server, which mediation server may convert or reformat a transmission for display on a mobile communications device on which the client is not operatively coupled.

6. The communications platform of claim 1, wherein at least one mobile communications device comprises a browser capable of communicating with and displaying a transmission received from the at least one server.

7. The communications platform of claim 1, wherein the communications platform provides an option for utilizing either Internet not dependent upon a data carrier's network or carrier's transmission facility thereby providing an independent communication platform for distribution and transmission of data or use of a mobile carrier network.

8. The communications platform of claim 1, wherein the transmission is a live broadcast.

9. The communications platform of claim 2, wherein the transmission is a live video broadcast.

10. The communications platform of claim 2, wherein the transmission is a live audio broadcast.

11. The communications platform of claim 1, wherein a mobile broadcast communications app transmits in communication with the server.

12. The communications platform of claim 11, wherein said mobile broadcast communications app includes a user list of contacts for a user originator to select specific users of the app to receive notification and ability to view the transmission.

13. A communications platform comprising:
a. at least one server,
b. at least on transport layer, and
c. at least one client comprising at least one application operatively coupled to the at least one transport layer and operatively coupled to at least one mobile communications device,
d. the client being capable of communicating with the at least one server of the platform over the transport layer,
e. the client also being capable of receiving a transmission from the at least one server over the transport layer, and
f. the client being further capable of displaying said transmission on the at least one mobile communications device upon prompting from the at least one server.

14. The communications platform of claim 13, wherein the client is further capable of transmitting a transmission from the mobile communications device over the transport layer.

15. The communications platform of claim 13, wherein the transmission is a streaming live broadcast transmitted over the at least one transport layer.

16. The communications platform of claim 15, comprising error correction technology, compression and validation software integrated within the at least one server to provide seamless and error free streaming of the transmission.

17. The communications platform of claim 15, wherein the live broadcast is a video broadcast.

18. The communications platform of claim 15, wherein the live broadcast is an audio broadcast.

19. The communications platform of claim 13, wherein there are at least two transport layers, said transport layers including Internet Protocol (IP) backbone and a network operator infrastructure from a carrier, wherein the client provides the ability to select which transport layer to carry out the transmission.

20. The communications platform of claim 13, wherein the transport layer is an Internet Protocol (IP) backbone.

21. The communications platform of claim 13, wherein the transport layer is a network operator infrastructure from a carrier.

22. The communications platform of claim 13, comprising a mobile broadcasting communication cloud fully powered by an Internet Protocol (IP) backbone.

23. The communications platform of claim 22, wherein the cloud is fully powered by an Internet Protocol (IP) backbone streamed to the server.

24. The communications platform of claim 23, wherein the server is backed up by a high speed data network, which in turn broadcasts the transmission to a network of user of the communications platform.

25. The communications platform of claim 13, wherein the server is backed up by a high speed data network, which in turn broadcasts the transmission to a network of client mobile communications devices on the communications platform.

26. The communications platform of claim 25, wherein the server is backed up by a high speed data network, which in turn broadcasts the transmission to selected clients of the network of client mobile communications devices on the communications platform.

27. The communications platform of claim 13, wherein the server is backed up by a high speed data network, which in turn broadcasts the transmission to a web site adapted to be accessed by non-client mobile communications devices.

28. The communications platform of claim 13, wherein the transmission is broadcasted on a selected channel.

29. The communications platform of claim 28, wherein there are a plurality of transmissions, each broadcasted to selected channels so that the devices can browse the channels for access to each transmission.

30. The communications platform of claim 29, wherein transmissions are categorized in categories and arranged to form at least one content selection page for at least one client.

31. A mobile cloud application system for a mobile communications platform for use with a wireless interactive device capable of receiving and transmitting messages, accepting user interface input, and displaying messages on an electronic display, the mobile cloud application system comprising:
a. at least one server,
b. an Internet Protocol (IP) backbone transport layer for Wi-Fi connectivity, and
c. at least one client comprising at least one application operatively coupled to the at least one transport layer and operatively coupled to at least one wireless interactive device,
d. the client being capable of communicating with the at least one server over the transport layer,
e. the client also being capable of receiving a transmission from the at least one server over the transport layer, and
f. the client being further capable of displaying said transmission on the at least one mobile communications device upon prompting from the at least one server.

32. The mobile cloud application system of claim 31, wherein the transmission is a live broadcast, and the live broadcast is adapted to be recorded by at least one wireless interactive device and transmitted by the client through the mobile cloud application system for live streaming to at least one other wireless interactive device.

33. The mobile cloud application system of claim 31 comprising at least a second transport layer comprising a 3G or 4G network associated with a mobile device operator.

34. The mobile cloud application system of claim 31, wherein the communications platform is not dependent upon a 3G or 4G network/data carrier network associated with a mobile device operator, thereby providing an independent communication platform for distribution and transmission of data over IP protocol.

35. A communications method comprising the steps of:
a. streaming at least one live broadcast from at least one wireless interactive device to at least one cloud with a server having error correction technology, compression and validation software, over a mobile cloud application system for a mobile communications platform comprising:
i. at least one server,
ii. an Internet Protocol (IP) backbone transport layer for Wi-Fi connectivity, and
iii. at least one client comprising at least one application operatively coupled to the at least one transport layer and operatively coupled to the at least one wireless interactive device,
iv. the client being capable of communicating with the at least one server over the transport layer,
v. the client also being capable of receiving the live broadcast transmission from the at least one server over the transport layer, and
vi. the client being further capable of displaying said transmission on the at least one mobile communications device upon prompting from the at least one server.
b. at least one other wireless interactive device being capable of streaming and displaying the live broadcast.
